(19) United States
(12) Patent Application Publication
(10) Pub. No.: US 2025/0308752 A1
(43) Pub. Date: Oct. 2, 2025

(54) COIL COMPONENT

(71) Applicant: Murata Manufacturing Co., Ltd., Kyoto-fu (JP)

(72) Inventors: Keita ASAI, Nagaokakyo-shi (JP); Hayato TAKAHASHI, Nagaokakyo-shi (JP)

(73) Assignee: Murata Manufacturing Co., Ltd., Kyoto-fu (JP)

(21) Appl. No.: 19/088,737

(22) Filed: Mar. 24, 2025

(30) Foreign Application Priority Data
Mar. 28, 2024 (JP) 2024-054668

(51) Int. Cl. H01F 27/28; H01F 17/04; H01F 27/29; H01F 27/30

(52) U.S. Cl. CPC H01F 27/2823; H01F 17/045; H01F 27/29; H01F 27/306

(57) ABSTRACT

A difference in the number of turns between first and second wires in contact with each other is changed without requiring a space in a direction along a central axis as much as possible. An m-th turn (where m is a positive integer) and an (m+1)-th turn of a first wire belong to a first layer, and an n-th turn (where n is an integer equal to or greater than m+2) of the first wire includes a first portion that belongs to a second layer and is wound from an outside in a direction orthogonal to a central axis on a valley portion between the m-th turn and the (m+1)-th turn of the first wire. Further, the second wire includes at least one turn wound adjacent to the first portion on a first flange side in the direction along the central axis.

### CROSS-REFERENCE TO RELATED APPLICATION

This application claims benefit of priority to Japanese Patent Application No. 2024-054668, filed Mar. 28, 2024, the entire content of which is incorporated herein by reference.

### BACKGROUND

### Technical Field

The present disclosure relates to a coil component.

### Background Art

The coil component described in Japanese Patent Application Laid-Open No. 2018-120887 includes a winding core, a first flange, and a second flange. The winding core has a quadrangular prism shape. The first flange is connected to a first end of the winding core. The second flange is connected to a second end of the winding core. Further, the coil component includes four external electrodes, a first wire, and a second wire. Two of the four external electrodes are located on a surface of the first flange. The remaining two external electrodes are located on a surface of the second flange.

The first wire is wound around the winding core. The first end of the first wire is connected to the external electrode on the first flange. The second end of the first wire is connected to the external electrode on the second flange side. The second wire is wound around the winding core. The first end of the second wire is connected to the external electrode on the first flange. The second end of the second wire is connected to the external electrode on the second flange. The second wire is wound in the same direction as the first wire outside the first wire as a whole.

### SUMMARY

In the coil component as described in Japanese Patent Application Laid-Open No. 2018-120887, a stray capacitance may be generated at a portion where the wires are in contact with each other. In addition, the larger the difference in the number of turns between the first wire and the second wire at the contact portion, the larger the stray capacitance. The coil component described in Japanese Patent Application Laid-Open No. 2018-120887 includes a portion where the second wire and the first wire intersect with each other in order to change a difference in the number of turns between the first wire and the second wire in contact with each other. However, in the coil component described in Japanese Patent Application Laid-Open No. 2018-120887, a large space is required in the direction along the central axis in the vicinity of the intersection portion in order to intersect the wires. For this reason, it is desired to design so that the difference in the number of turns between the first wire and the second wire in contact is changed without requiring a space in the direction along the central axis as much as possible.

Accordingly, the present disclosure provides a coil component including a winding core, a first flange provided at a first end of the winding core in a direction along a central axis, a second flange provided at a second end of the winding core opposite to the first end, a first external electrode and a second external electrode provided on the first flange, a third external electrode and a fourth external electrode provided on the second flange, a first wire wound around the winding core and having a first end connected to the first external electrode and a second end connected to the third external electrode, and a second wire wound around the winding core in a same direction as the first wire. The second wire has a first end connected to the second external electrode and a second end connected to the fourth external electrode, in which regarding the first wire and the second wire, a number of turns increases by one every time one turn is made around the central axis from the first end toward the second end. Also, when a portion directly wound around the winding core is defined as a first layer, a portion wound from an outside of the first layer in a direction orthogonal to the central axis is defined as a second layer, and a portion wound from an outside of the second layer in the direction orthogonal to the central axis is defined as a third layer, an m-th turn (where m is a positive integer) and an (m+1)-th turn of the first wire include a portion belonging to the first layer, an n-th turn (where n is an integer equal to or greater than m+2) of the first wire includes a first portion that belongs to the second layer and is wound from the outside in the direction orthogonal to the central axis on a valley portion between the m-th turn and the (m+1)-th turn of the first wire, the second wire includes at least one or more turns wound on a side of the first flange with respect to the first portion in the direction along the central axis, and includes at least one or more turns wound on a side of the second flange with respect to the first portion in the direction along the central axis, and an a-th turn (where a is an integer equal to or greater than 2) of the second wire includes a second portion belonging to the third layer.

With the above configuration, the difference in the number of turns between the first wire and the second wire in contact with each other can be changed without requiring a space in the direction along the central axis of the winding core as much as possible.

### BRIEF DESCRIPTION OF THE DRAWINGS

FIG. 1 is a perspective view of a coil component of a first embodiment;

FIG. 2 is a schematic end view illustrating a part of the coil component of the first embodiment including a central axis and orthogonal to a left-right axis;

FIG. 3 is a schematic end view illustrating a part of a coil component of a second embodiment including a central axis and orthogonal to the left-right axis;

FIG. 4 is a schematic end view illustrating a part of a component of a coil of a modification including a central axis and orthogonal to the left-right axis;

FIG. 5 is a schematic end view illustrating a part of a component of a coil of a modification including a central axis and orthogonal to the left-right axis;

FIG. 6 is a schematic end view illustrating a part of a component of a coil of a modification including a central axis and orthogonal to the left-right axis; and

FIG. 7 is a schematic end view illustrating a part of a coil component of a modification including a central axis and orthogonal to the left-right axis.

### DETAILED DESCRIPTION

Hereinafter, a first embodiment and a second embodiment of a coil component will be described with reference to the drawings. Note that in the drawings, components may be shown in an enlarged manner for easy understanding. In some cases, the dimension ratio of a component differs from an actual dimension ratio or a dimension ratio in another drawing.

### First Embodiment

### <Overall Configuration>

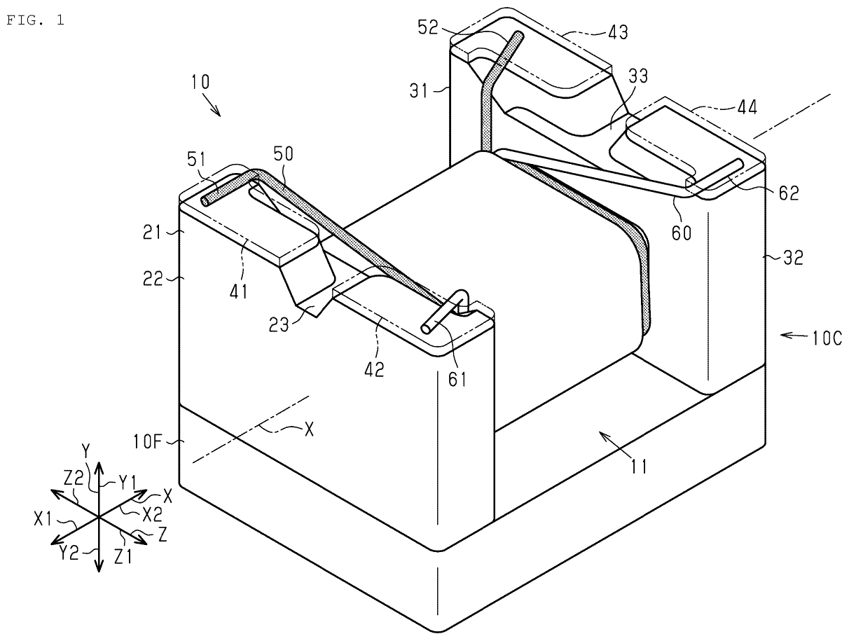

As illustrated in FIG. 1, a coil component 10 includes a drum core 10C and a plate core 10F.

The drum core 10C includes a winding core 11, a first flange 21, and a second flange 31. The winding core 11 has a quadrangular prism shape. The material of the winding core 11 is, for example, Ni—Zn-based ferrite or the like.

The first flange 21 is provided at a first end of the winding core 11 in a direction along a central axis X. Specifically, the first flange 21 is connected to the first end of the winding core 11 in the direction along the central axis X. The second flange 31 is provided at a second end of the winding core 11 in the direction along the central axis X. Specifically, the second flange 31 is connected to the second end of the winding core 11 in the direction along the central axis X. A material of the first flange 21 and the second flange 31 is the same as that of the winding core 11. Further, the first flange 21 and the second flange 31 are integrally molded with the winding core 11.

Here, a specific axis orthogonal to the central axis X is defined as an up-down axis Y. In the first embodiment, the up-down axis Y is a direction orthogonal to the mounting surface when the coil component 10 is mounted on the substrate.

Further, when viewed in the direction along the central axis X, the up-down axis Y is parallel to a short side of the winding core 11. Furthermore, an axis orthogonal to both the central axis X and the up-down axis Y is defined as a left-right axis Z. In the first embodiment, the left-right axis Z is parallel to a long side of the winding core 11 when viewed in the direction along the central axis X. One of directions along the central axis X is defined as a positive direction X1, and a direction opposite to the positive direction X1 is defined as a negative direction X2. In the first embodiment, the positive direction X1 coincides with a direction from the winding core 11 toward the first flange 21. The negative direction X2 coincides with a direction from the winding core 11 toward the second flange 31. Further, one of directions along the up-down axis Y is defined as an upward direction Y1, and a direction opposite to the upward direction Y1 is defined as a downward direction Y2. Furthermore, one of directions along the left-right axis Z is defined as a rightward direction Z1, and a direction opposite to the rightward direction Z1 is defined as a leftward direction Z2. Note that the upward direction Y1 and the downward direction Y2 here are referred to for convenience and do not specify a gravity direction. Furthermore, the rightward direction Z1 and the leftward direction Z2 are also referred to for convenience, and are not intended to limit a left and right direction from a specific viewpoint.

Note that, in the present disclosure, an “upper surface” refers to a surface facing the upward direction Y1 in a direction along the up-down axis Y, and a “lower surface” refers to a surface facing the downward direction Y2. The “upper surface” is not necessarily orthogonal to the upward direction Y1, and for example, when the coil component 10 is viewed from the upward direction Y1 to the downward direction Y2 with respect to the coil component 10, a visible surface is referred to as an “upper surface of the coil component 10”. In this respect, the same applies to the lower surface.

The first flange 21 protrudes outward with respect to the winding core 11 in directions along the up-down axis Y and the left-right axis Z when viewed in the direction along the central axis X. The first flange 21 has a plane-symmetrical shape with respect to a virtual plane including the central axis X and orthogonal to the left-right axis Z.

The first flange 21 includes a main body 22 and a recessed portion 23. The main body 22 has a substantially rectangular parallelepiped shape with a small thickness in the direction along the central axis X. When viewed in the negative direction X2, both edges of the main body 22 in the upward direction Y1 and the downward direction Y2 are parallel to the left-right axis Z. Further, when viewed in the negative direction X2, both edges of the main body 22 in the leftward direction Z2 and the rightward direction Z1 are parallel to the up-down axis Y.

The recessed portion 23 is recessed from the upper surface of the main body 22 toward the downward direction Y2 side. A dimension of the recessed portion 23 in the direction along the left-right axis Z decreases toward the downward direction Y2. The recessed portion 23 is located substantially at a center of the main body 22 in the direction along the left-right axis Z. A dimension of the recessed portion 23 in the direction along the central axis X is the same as a dimension of the main body 22 in the direction along the central axis X. That is, a portion of the first flange 21 on the upward direction Y1 side has a shape bifurcated with the recessed portion 23 interposed therebetween.

The second flange 31 and the first flange 21 have a plane-symmetrical shape with respect to a virtual plane passing through the center of the winding core 11 and orthogonal to the central axis X. That is, the second flange 31 protrudes outward with respect to the winding core 11 in the direction along the up-down axis Y and the direction along the left-right axis Z when viewed from the direction along the central axis X. The second flange 31 includes a main body 32 and a recessed portion 33. The configurations of the main body 32 and the recessed portion 33 of the second flange 31 are similar to those of the main body 22 and the recessed portion 23 of the first flange 21. That is, the recessed portion 33 is recessed from the upper surface of the main body 32 toward the downward direction Y2 side.

The plate core 10F has a rectangular plate shape. A long side of the plate core 10F is parallel to the central axis X. A short side of the plate core 10F is parallel to the left-right axis Z. The plate core 10F is located on the downward direction Y2 side with respect to the drum core 10C. The plate core 10F is connected to both a lower surface of the first flange 21 and a lower surface of the second flange 31. That is, the plate core 10F is bridged between the first flange 21 and the second flange 31. A material of the plate core 10F is the same as a material of the drum core 10C.

The coil component 10 includes a first external electrode 41, a second external electrode 42, a third external electrode 43, and a fourth external electrode 44. The first external electrode 41 is provided on the first flange 21. That is, the first external electrode 41 is attached onto a surface of the first flange 21. The first external electrode 41 is located on a surface of the first flange 21 on the upward direction Y1 side and on the leftward direction Z2 side with respect to the recessed portion 23.

The second external electrode 42 is provided on the first flange 21. That is, the second external electrode 42 is attached onto a surface of the first flange 21. The second external electrode 42 is located on a surface of the first flange 21 on the upward direction Y1 side and on the rightward direction Z1 side with respect to the recessed portion 23.

The third external electrode 43 is provided on the second flange 31. That is, the third external electrode 43 is attached onto a surface of the second flange 31. The third external electrode 43 is located on a surface of the second flange 31 on the upward direction Y1 side and on the leftward direction Z2 side with respect to the recessed portion 33.

The fourth external electrode 44 is provided on the second flange 31. That is, the fourth external electrode 44 is attached onto a surface of the second flange 31. The fourth external electrode 44 is located on a surface of the second flange 31 on the upward direction Y1 side and on the rightward direction Z1 side with respect to the recessed portion 33.

Although not illustrated, these first external electrode 41 to fourth external electrode 44 include a metal layer and a plating layer. The metal layer is, for example, a layer containing silver as a main component. The plating layer includes, for example, a plurality of layers such as a layer containing copper as a main component, a layer containing nickel as a main component, and a layer containing tin as a main component. In the present embodiment, the surfaces of the coil component 10 on which the first external electrode 41 to the fourth external electrode 44 are provided are surfaces facing a substrate when the coil component 10 is mounted on the substrate. Note that, in FIG. 1, the first external electrode 41 to the fourth external electrode 44 are depicted by alternate long and short dash lines.

### <Configurations of First Wire and Second Wire>

As illustrated in FIG. 1, the coil component 10 includes a first wire 50 and a second wire 60. The first wire 50 and the second wire 60 include portions wound around the winding core 11. Note that, in FIG. 1, a winding structure of the portion of the first wire 50 and the second wire 60 wound around the winding core 11 is simplified, and each turn is illustrated as a tubular object integrated in each wire.

Although not illustrated, the first wire 50 includes a conductive wire and an insulating film. The insulating film covers an outer surface of the conductive wire. The first wire 50 has a substantially circular shape in a section orthogonal to a direction in which the first wire 50 extends. The first wire 50 includes a first end 51 and a second end 52 opposite to the first end 51. Note that, in each drawing, the first wire 50 is colored with dots.

As illustrated in FIG. 1, the first end 51 of the first wire 50 is connected to the first external electrode 41. The second end 52 of the first wire 50 is connected to the third external electrode 43. Here, when the first wire 50 is traced from the first end 51 to the second end 52, a portion that first comes into contact with an outer peripheral surface of the winding core 11 is defined as a 1.0 turn portion of the first wire 50. In the first embodiment, the 1.0 turn portion of the first wire 50 is located on a ridgeline on the rightward direction Z1 side and the upward direction Y1 side of the winding core 11.

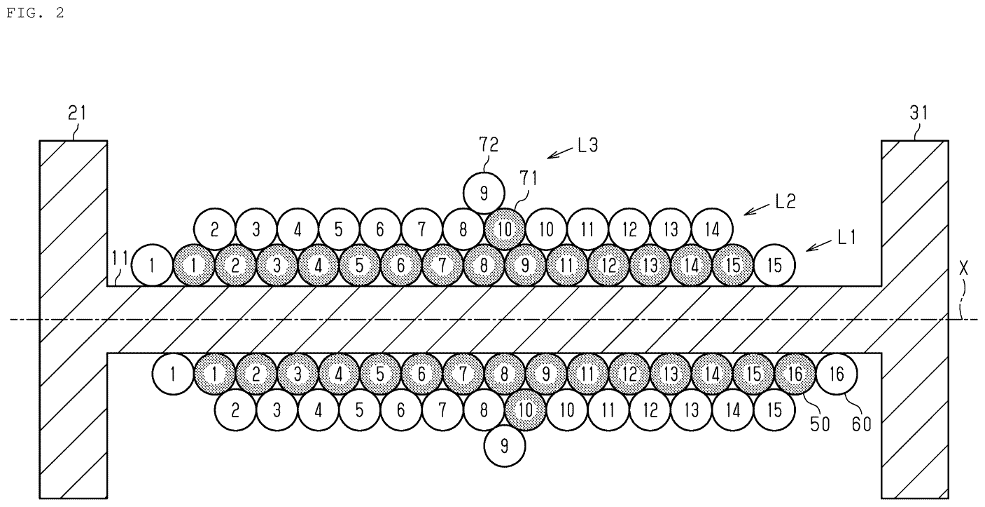

As illustrated in FIG. 2, with respect to the first wire 50, the number of turns of the first wire 50 is increased by 1 every time one turn is made around the central axis X from the first end 51 toward the second end 52. The first wire 50 is wound around the winding core 11 so as to travel clockwise as the number of turns increases when viewed in the negative direction X2. Therefore, for example, when viewed in the negative direction X2, a portion that travels 36 degrees about the central axis X from the 1.0 turn portion of the first wire 50 is a 1.1 turn portion of the first wire 50. Further, the first turn of the first wire 50 indicates a portion of the first wire 50 from a portion of 1.0 turn to immediately before a portion of 2.0 turns. Note that, in FIGS. 2 to 7, any portion of the first turn is indicated as “1” as long as the portion is within the range of the first turn. The same applies to other numbers of turns. The number of turns illustrated in FIG. 2 need not coincide with the number of turns counted from the start of winding in manufacturing.

As illustrated in FIG. 1, the second wire 60 has a configuration similar to that of the first wire 50. That is, the second wire 60 includes a conductive wire and an insulating film. The insulating film covers an outer surface of the conductive wire. The second wire 60 has a substantially circular shape in a section orthogonal to a direction in which the second wire 60 extends. The second wire 60 includes a first end 61 and a second end 62 opposite to the first end 61.

As illustrated in FIG. 1, the first end 61 of the second wire 60 is connected to the second external electrode 42. The second end 62 of the second wire 60 is connected to the fourth external electrode 44. Here, when the second wire 60 is traced from the first end 61 to the second end 62, a portion where an angular position about the central axis X first coincides with an angular position of a 1.0 turn portion of the first wire 50 is defined as a 1.0 turn portion of the second wire 60. That is, in the first embodiment, the 1.0 turn portion of the second wire 60 is located on a straight line connecting a ridge line on the rightward direction Z1 side and the upward direction Y1 side of the winding core 11 and the central axis X when viewed toward the direction along the central axis X.

As illustrated in FIG. 2, with respect to the second wire 60, the number of turns of the second wire 60 is increased by 1 every time one turn is made around the central axis X from the first end 61 toward the second end 62. The second wire 60 is wound around the winding core 11 so as to travel clockwise as the number of turns increases when viewed in the negative direction X2.

Regarding the first wire 50 and the second wire 60, a portion directly wound around the winding core 11 is defined as a first layer L1. Here, “directly wound” includes not only a state where the wire is in contact with the outer peripheral surface of the winding core 11 but also a state where the wire is wound on the winding core 11 without interposing another wire in a state where the wire is floated with respect to the winding core 11.

Further, regarding the first wire 50 and the second wire 60, a portion wound on a valley portion formed by two turns of the first layer L1 adjacent in the direction along the central axis X from the outside in the direction orthogonal to the central axis X is defined as a second layer L2.

Furthermore, regarding the first wire 50 and the second wire 60, a portion wound on a valley portion formed by two turns of the second layer L2 adjacent in the direction along the central axis X from the outside in the direction orthogonal to the central axis X is defined as a third layer L3.

### Winding Mode of Wire of First Embodiment

As illustrated in FIG. 2, the first wire 50 includes a portion belonging to the first layer L1 from the first turn to the middle of the ninth turn. The first turn to the ninth turn of the first wire 50 are sequentially wound so as to be located closer to the second flange 31 side in the direction along the central axis X as the number of turns increases. Further, each of the first turn to the ninth turn of the first wire 50 is wound adjacent to each other in the direction along the central axis X. Here, “wound adjacent to each other” is not limited to a case where turns of adjacent wires are in contact with each other. If the turns of the adjacent wires are not in contact with each other, it can be said that the wires are adjacent to each other if no other wire exists on the line segment connecting the central axes of the adjacent wires in a sectional view.

The 10th turn of the first wire 50 includes a first portion 71 belonging to the second layer L2. Specifically, the first portion 71 is wound from the outside in the direction orthogonal to the central axis X on the valley portion between the eighth turn and the ninth turn of the first wire 50. Therefore, the pitch of the spiral of the first wire 50 is negative in the portion from the ninth turn to the 10th turn. Thus, when n is 10 and m is 8 (n=m+2), the n-th turn of the first wire 50 includes the first portion 71 wound from the outside in the direction orthogonal to the central axis X on the valley portion between the m-th turn and the (m+1)-th turn of the first wire 50. Note that a portion of the first portion 71 that rides on the second layer L2 need not be exactly the portion of 10.0 turns. For example, the portion of the first portion 71 that rides on may be after 10.0 turns. In this case, a part of the first wire 50 including the portion of 10.0 turns in the 10th turn may belong to the first layer L1. In addition, a part of the 11th turn including 11.0 turns of the first wire 50 may belong to the second layer L2 continuously with the first portion 71. In this case, the part of the 11th turn of the first wire 50 may belong to the second layer L2. In addition, a part of the first wire 50 before 10.0 turns may belong to the second layer L2 continuously with the first portion 71. In this case, a part of the ninth turn of the first wire 50 may belong to the second layer L2.

The 11th turn of the first wire 50 includes a portion belonging to the first layer L1. The 11th turn of the first wire 50 is wound adjacent to the ninth turn of the first wire 50 on the second flange 31 side in the direction along the central axis X. Therefore, the pitch of the spiral of the first wire 50 is larger in a portion from the 10th turn to the 11th turn than in other portions.

The 12th turn to the 15th turn of the first wire 50 belong to the first layer L1. The 12th turn of the first wire 50 is wound adjacent to the 11th turn of the first wire 50 on the second flange 31 side in the direction along the central axis X. The 12th turn to the 15th turn of the first wire 50 are sequentially wound so as to be located closer to the second flange 31 side in the direction along the central axis X as the number of turns increases. Further, each of the 12th turn to the 15th turn of the first wire 50 is wound adjacent to each other in the direction along the central axis X.

The 16th turn of the first wire 50 includes a portion wound around the winding core 11 and a portion separated from the winding core 11 and connected to the third external electrode 43. The portion wound around the winding core 11 in the 16th turn of the first wire 50 belongs to the first layer L1. The portion of the 16th turn of the first wire 50 is wound adjacent to the 15th turn of the first wire 50 on the second flange 31 side in the direction along the central axis X.

The first turn of the second wire 60 includes a portion belonging to the first layer L1. The portion is wound adjacent to the first turn of the first wire 50 on the first flange 21 side in the direction along the central axis X.

The second turn to the middle of the eighth turn of the second wire 60 belong to the second layer L2. Note that a part of the second turn of the first wire 50 may belong to the first layer L1.

The second turn to the middle of the eighth turn of the second wire 60 are wound so as to be located closer to the second flange 31 side in the direction along the central axis X as the number of turns increases. Each of the second turn to the middle of the eighth turn of the second wire 60 is wound adjacent to each other in the direction along the central axis X. Further, the second turn of the second wire 60 is wound from the outside in the direction orthogonal to the central axis X on the valley portion between the first turn and the second turn of the first wire 50. That is, the i-th turn (where i is an integer between 2 and 8, inclusive) of the second wire 60 is wound from the outside in the direction orthogonal to the central axis X on the valley portion between the (i−1)-th turn and the i-th turn of the first wire 50. Further, the eighth turn of the second wire 60 includes a portion wound adjacent to the 10th turn of the first wire 50 on the first flange 21 side. That is, the eighth turn of the second wire 60 includes a portion wound on the first flange 21 side with respect to the first portion 71 in the direction along the central axis X. In other words, the second wire 60 includes at least one or more turns wound on the first flange 21 side with respect to the first portion 71 in the direction along the central axis X.

As described above, the first turn to the ninth turn of the first wire 50 are wound so as to be located closer to the second flange 31 side in the direction along the central axis X as the number of turns increases. Therefore, the i-th turn of the second wire 60 wound on the valley portion between the (i−1)-th turn and the i-th turn of the first wire 50 is located on the first flange 21 side in the direction along the central axis X with respect to the i-th turn of the first wire 50. That is, when the same turns of the first wire 50 and the second wire 60 are compared, in the turns from the second turn to the eighth turn, the second wire 60 is located on the first flange 21 side with respect to the same turn of the first wire 50 in the direction along the central axis X. Note that “the second wire 60 is located on the first flange 21 side with respect to the first wire 50” means that the center of each turn of the second wire 60 is located on the first flange 21 side with respect to the center of each turn of the first wire 50 in the direction along the central axis X when each wire is viewed from the end surface as illustrated in FIG. 2.

The ninth turn of the second wire 60 includes a second portion 72 belonging to the third layer L3. Specifically, the second portion 72 is wound from the outside in the direction orthogonal to the central axis X on the valley portion between the eighth turn of the second wire 60 and the 10th turn of the first wire 50. Thus, when a is 9, the a-th turn of the second wire 60 includes the second portion 72 belonging to the third layer L3. Note that a part of the ninth turn of the second wire 60 may belong to the second layer L2. Further, a part of the eighth turn of the second wire 60 may belong to the third layer L3.

The 10th turn of the second wire 60 includes a portion belonging to the second layer L2. Specifically, the 10th turn of the second wire 60 includes a portion wound from the outside in the direction orthogonal to the central axis X on the valley portion between the ninth turn and the 11th turn of the first wire 50. The portion is wound adjacent to the 10th turn of the first wire 50 on the second flange 31 side in the direction along the central axis X. That is, the 10th turn of the second wire 60 includes a portion wound on the second flange 31 side with respect to the first portion 71 in the direction along the central axis X. In other words, the second wire 60 includes at least one or more turns wound on the second flange 31 side with respect to the first portion 71 in the direction along the central axis X.

The 11th turn to the middle of the 15th turn of the second wire 60 belong to the second layer L2. The 11th turn to the middle of the 15th turn of the second wire 60 are sequentially wound so as to be located closer to the second flange 31 side in the direction along the central axis X as the number of turns increases. Each of the 11th turn to the middle of the 15th turn of the second wire 60 is wound adjacent to each other in the direction along the central axis X. Further, the 11th turn of the second wire 60 is wound from the outside in the direction orthogonal to the central axis X on the valley portion between the 11th turn and the 12th turn of the first wire 50. That is, up to the middle of the j-th turn of the second wire 60 (where j is an integer between 11 and 15, inclusive) is wound from the outside in the direction orthogonal to the central axis X on the valley portion between the j-th turn and the (j+1)-th turn of the first wire 50.

As described above, the 11th turn to the 15th turn of the first wire 50 are sequentially wound so as to be located closer to the second flange 31 side in the direction along the central axis X as the number of turns increases. Therefore, the j-th turn of the second wire 60 wound on the valley portion between the j-th turn and the (j+1)-th turn of the first wire 50 is located on the second flange 31 side in the direction along the central axis X with respect to the j-th turn of the first wire 50. That is, when the same turns of the first wire 50 and the second wire 60 are compared, in the turns from the 11th turn to the 15th turn, the first wire 50 is located on the first flange 21 side with respect to the same turn of the second wire 60 in the direction along the central axis X. Note that “the first wire 50 is located on the first flange 21 side with respect to the second wire 60” means that the center of each turn of the second wire 60 is located on the second flange 31 side with respect to the center of each turn of the first wire 50 when each wire is viewed from the end surface as illustrated in FIG. 2.

The remaining portion of the 15th turn of the second wire 60, specifically, the portion including the portion wound on an upper surface side of the winding core 11 in the 15th turn belongs to the first layer L1. That is, the 15th turn of the second wire 60 includes a portion wound around the second layer L2 and a portion wound around the first layer L1. The portion of the 15th turn of the second wire 60 is wound adjacent to the 15th turn of the first wire 50 on the second flange 31 side in the direction along the central axis X.

The 16th turn of the second wire 60 includes a portion wound around the winding core 11 and a portion separated from the winding core 11 and connected to the fourth external electrode 44. The portion wound around the winding core 11 in the 16th turn of the second wire 60 belongs to the first layer L1. The portion of the 16th turn of the second wire 60 is wound adjacent to the 16th turn of the first wire 50 on the second flange 31 side in the direction along the central axis X. That is, in the 11th and subsequent turns of the second wire 60, the first wire 50 is located on the first flange 21 side with respect to the same turn of the second wire 60 in the direction along the central axis X. Further, when the second wire 60 is traced from the first end 61 to the second end 62, the second wire 60 is located closer to the second flange 31 side in the direction along the central axis X as the number of turns increases. Note that “the second wire 60 is located closer to the second flange 31 side in the direction along the central axis X as the number of turns increases” means that the center of each turn of the second wire 60 is located on the second flange 31 side with respect to the center of each previous turn in the direction along the central axis X when each wire is viewed from the end surface as illustrated in FIG. 2.

### Stray Capacitance of First Embodiment

In the following description, it is assumed that substantially the same positive voltage is applied to the first end 51 of the first wire 50 and the first end 61 of the second wire 60, and a ground voltage as a reference voltage is applied to the second end 52 of the first wire 50 and the second end 62 of the second wire 60.

In each turn of the second wire 60 in contact with each turn of the first wire 50, a stray capacitance generated between adjacent turns of each wire increases as the difference in the number of turns increases. For example, as illustrated in FIG. 2, the turns of the second wire 60 in contact with the first turn of the first wire 50 are the first turn and the second turn. At this time, it can be said that a large potential difference is not generated between the first turn of the first wire 50 and the first turn of the second wire 60. On the other hand, when the potential of the first turn of the first wire 50 is compared with the potential of the second turn of the second wire 60, it can be said that the potential of the first turn of the first wire 50 is larger. Therefore, a stray capacitance corresponding to the potential difference is generated between the first turn of the first wire 50 and the first turn of the second wire 60.

Here, a stray capacitance generated when the potential of the first wire 50 is higher than the potential of the second wire 60 by one turn when the turn of the first wire 50 and the turn of the second wire 60 in contact with each other are compared is defined as a positive unit capacitance A. Specifically, a stray capacitance generated between the k-th turn (k is a positive integer) of the first wire 50 and the (k+1)-th turn of the second wire 60 in contact therewith is defined as one positive unit capacitance A. In this case, a stray capacitance generated between the k-th turn of the first wire 50 and the (k+2)-th turn of the second wire 60 in contact therewith is equivalent to two positive unit capacitances A.

In a case where the unit capacitance A is determined as described above, when the turn of the first wire 50 and the turn of the second wire 60 in contact with each other are compared, a stray capacitance generated by the potential of the second wire 60 being higher than the potential of the first wire 50 by one turn is a negative unit capacitance B. The negative unit capacitance B has the same absolute value as the positive unit capacitance A, and the positive and negative values are opposite. Specifically, a stray capacitance generated between the k-th turn of the second wire 60 and the (k+1)-th turn of the first wire 50 in contact therewith is one negative unit capacitance B. Further, a stray capacitance generated between the k-th turn of the second wire 60 and the (k+2)-th turn of the first wire 50 in contact therewith is a negative unit capacitance B.

In the first embodiment, the coil component 10 includes eight positive unit capacitances A and eight negative unit capacitances B. Therefore, the positive stray capacitance and the negative stray capacitance are substantially the same when viewed from the entire coil component 10. In other words, the stray capacitance generated by the high potential of the first wire 50 is substantially equal to the stray capacitance generated by the high potential of the second wire 60.

### Effects of First Embodiment

(1-1) In the first embodiment, the (m+2)-th turn of the first wire 50 includes the first portion 71 wound from the outside in the direction orthogonal to the central axis X on the valley portion between the m-th turn and the (m+1)-th turn of the first wire 50. That is, the (m+2)-th turn of the first wire 50 is wound back around the (m+1)-th turn. As described above, since the second wire 60 is wound across the portion where the first wire 50 is wound back and wound, the difference in the number of turns between the first wire 50 and the second wire 60 in contact before and after the winding is changed.

Specifically, in the first embodiment, the seventh turn of the second wire 60 includes a portion in contact with the sixth turn and the seventh turn of the first wire 50. As described above, a portion where the number of turns is smaller than that of the first portion 71 includes a portion where the (i−1)-th turn and the (i+1)-th turn of the first wire 50 are in contact with the i-th turn of the second wire 60. Further, the 11th turn of the second wire 60 includes a portion in contact with the 11th turn and the 12th turn of the first wire 50. At a portion where the number of turns is larger than that of the first portion 71, the j-th turn and the (j+1)-th turn of the first wire 50 are in contact with the j-th turn of the second wire 60. In this manner, the difference in the number of turns between the first wire 50 and the second wire 60 in contact before and after the first portion 71 is changed.

Further, in the first embodiment, the first wire 50 includes the first portion 71. Thus, the space for winding the first wire 50 in the direction along the central axis X is reduced as compared with the configuration in which the entire first wire 50 belongs to the first layer L1. Furthermore, in the first embodiment, the second wire 60 includes the second portion 72. Thus, the space for winding the second wire 60 in the direction along the central axis X is reduced as compared with the configuration in which the entire second wire 60 belongs to the first layer L1 and the second layer L2. Thus, with the above configuration, the difference in the number of turns between the first wire 50 and the second wire 60 in contact with each other can be changed while reducing the space in the direction along the central axis X in each wire.

(1-2) In the first embodiment, the m-th turn of the second wire 60 is located closer to the first flange 21 side than the m-th turn of the first wire 50 in the direction along the central axis X. On the other hand, the n-th turn of the second wire 60 is located closer the second flange 31 side than the n-th turn of the first wire 50 in the direction along the central axis X. That is, when an anteroposterior relationship of the same turn of each wire is compared, the anteroposterior relationship is reversed from the m-th turn to the n-th turn. With such a configuration, the positive and negative of the stray capacitance can be changed before the m-th turn and after the n-th turn of the second wire 60.

(1-3) In the first embodiment, when the same turns of the first wire 50 and the second wire 60 are compared, in the turns from the second turn to the (m−1)-th turn, the second wire 60 is located on the first flange 21 side with respect to the same turn of the first wire 50 in the direction along the central axis X. When the same turns of the first wire 50 and the second wire 60 are compared, in the (n+1)-th and subsequent turns, the first wire 50 is located on the first flange 21 side with respect to the same turn of the second wire 60 in the direction along the central axis X. With this configuration, the positive and negative of the stray capacitances of the first wire 50 and the second wire 60 are switched only by the portion from the m-th turn to the n-th turn. Thus, in the coil component 10 as a whole, at least a part of the stray capacitance generated in less than the m-th turn can be offset by the stray capacitance generated in the turn larger than the n-th turn.

(1-4) In the first embodiment, when the second wire 60 is traced from the first end 61 to the second end 62, the second wire 60 is located closer to the second flange 31 side in the direction along the central axis X as the number of turns increases. In other words, the second wire 60 is wound without being rewound from the second flange 31 side to the first flange 21 side in the direction along the central axis X.

As compared with the configuration in which the second wire 60 includes rewinding, with the above configuration, the winding state of the second wire 60 is stabilized.

(1-5) In the first embodiment, the stray capacitance generated by the high potential of the first wire 50 is substantially equal to the stray capacitance generated by the high potential of the second wire 60. Therefore, the balance of the stray capacitance is excellent when the coil component 10 is viewed as a whole.

### Second Embodiment

Hereinbelow, a second embodiment of a coil component will be described. Note that, in the coil component of the second embodiment, the basic configurations of the drum core 10C, the plate core 10F, and the first wire 50, the basic configuration of the second wire 60, and the configurations of the first external electrode 41 to the fourth external electrode 44 are similar to those of the first embodiment. Hereinafter, a winding mode of the first wire 50 and the second wire 60 having a configuration different from that of the first embodiment will be described.

### Winding Mode of Wire of Second Embodiment

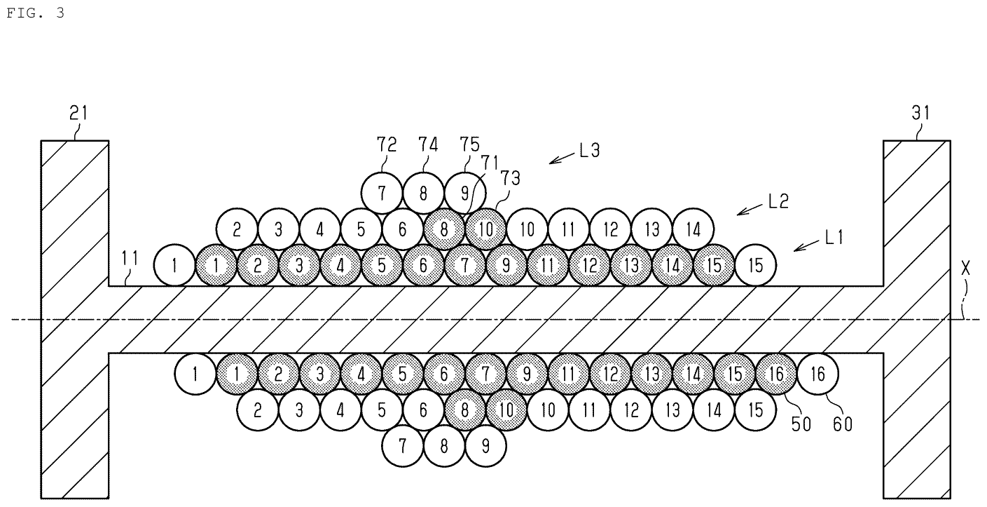

As illustrated in FIG. 3, a portion of the first wire 50 from the first turn to the middle of the seventh turn includes a portion belonging to the first layer L1. Further, the portion of the first wire 50 from the first turn to the middle of the seventh turn is sequentially wound so as to be located closer to the second flange 31 side in the direction along the central axis X as the number of turns increases. Furthermore, each of the first turn to the middle of the seventh turn of the first wire 50 is wound adjacent to each other in the direction along the central axis X.

The eighth turn of the first wire 50 includes a first portion 71 belonging to the second layer L2. Specifically, the first portion 71 is wound from the outside in the direction orthogonal to the central axis X on the valley portion between the sixth turn and the seventh turn of the first wire 50. Thus, when n is 8 and m is 6 (n=m+2), the n-th turn of the first wire 50 includes the first portion 71 wound from the outside in the direction orthogonal to the central axis X on the valley portion between the m-th turn and the (m+1)-th turn of the first wire 50. Note that a part of the eighth turn of the first wire 50 may belong to the first layer L1.

The ninth turn of the first wire 50 includes a portion belonging to the first layer L1. The portion is wound adjacent to the seventh turn of the first wire 50 on the second flange 31 side in the direction along the central axis X. Note that a part of the ninth turn of the first wire 50 may belong to the second layer L2.

The 10th turn of the first wire 50 includes a third portion 73 belonging to the second layer L2. Specifically, the third portion 73 is wound from the outside in the direction orthogonal to the central axis X on the valley portion between the seventh turn and the ninth turn of the first wire 50. That is, the (m+4)-th turn of the first wire 50 includes the third portion 73 that belongs to the second layer L2 and is wound from the outside in the direction orthogonal to the central axis X on the valley portion between the (m+1)-th turn and the (m+3)-th turn of the first wire 50. Note that a part of the 10th turn of the first wire 50 may belong to the first layer L1. The configurations of the 11th and subsequent turns of the first wire 50 are similar to those of the first embodiment.

The first turn of the second wire 60 includes a portion belonging to the first layer L1. The portion is wound adjacent to the first turn of the first wire 50 on the first flange 21 side in the direction along the central axis X.

The second turn to the sixth turn of the second wire 60 belong to the second layer L2. Note that a part of the second turn of the second wire 60 may belong to the first layer L1. The second turn to the sixth turn of the second wire 60 are sequentially wound so as to be located closer to the second flange 31 side in the direction along the central axis X as the number of turns increases. Each of the second turn to the sixth turn of the second wire 60 is wound adjacent to each other in the direction along the central axis X. Further, the second turn of the second wire 60 is wound from the outside in the direction orthogonal to the central axis X on the valley portion between the first turn and the second turn of the first wire 50. That is, the i-th turn (where i is an integer between 2 and 6, inclusive) of the second wire 60 is wound from the outside in the direction orthogonal to the central axis X on the valley portion between the (i−1)-th turn and the i-th turn of the first wire 50. Further, the sixth turn of the second wire 60 includes a portion wound adjacent to the eighth turn of the first wire 50 on the first flange 21 side. That is, the sixth turn of the second wire 60 includes a portion wound on the first flange 21 side with respect to the first portion 71 in the direction along the central axis X. In other words, the second wire 60 includes at least one or more turns wound on the first flange 21 side with respect to the first portion 71 in the direction along the central axis X.

As described above, the first wire 50 is sequentially wound from the first turn to the middle of the seventh turn so as to be located closer to the second flange 31 side in the direction along the central axis X as the number of turns increases. Therefore, the i-th turn of the second wire 60 wound on the valley portion between the (i−1)-th turn and the i-th turn of the first wire 50 is located on the first flange 21 side in the direction along the central axis X with respect to the i-th turn of the first wire 50. That is, when the same turns of the first wire 50 and the second wire 60 are compared, in the turns from the second turn to the sixth turn, the second wire 60 is located on the first flange 21 side with respect to the same turn of the first wire 50 in the direction along the central axis X. Note that “the second wire 60 is located on the first flange 21 side with respect to the first wire 50” is defined as in the first embodiment.

The seventh turn of the second wire 60 includes a second portion 72 belonging to the third layer L3. Specifically, the second portion 72 is wound from the outside in the direction orthogonal to the central axis X on the valley portion between the fifth turn and the sixth turn of the second wire 60. Thus, when a is 7, the a-th turn of the second wire 60 includes the second portion 72 belonging to the third layer L3. Note that a part of the seventh turn of the second wire 60 may belong to the second layer L2. Further, a part of the sixth turn of the second wire 60 may belong to the third layer L3.

The eighth turn of the second wire 60 includes a fourth portion 74 belonging to the third layer L3. Specifically, the fourth portion 74 is wound from the outside in the direction orthogonal to the central axis X on the valley portion between the sixth turn of the second wire 60 and the eighth turn of the first wire 50. In the second embodiment, the entire eighth turn of the second wire 60 is the fourth portion 74. That is, the (m+2)-th turn of the second wire 60 includes the fourth portion 74 that belongs to the third layer L3 and is wound from the outside in the direction orthogonal to the central axis X on the valley portion between the m-th turn of the second wire 60 and the (m+2)-th turn of the first wire 50.

The ninth turn of the second wire 60 includes a fifth portion 75 belonging to the third layer L3. Specifically, the fifth portion 75 is wound from the outside in the direction orthogonal to the central axis X on the valley portion between the eighth turn and the 10th turn of the first wire 50. That is, the (m+3)-th turn of the second wire 60 includes the fifth portion 75 that belongs to the third layer L3 and is wound from the outside in the direction orthogonal to the central axis X on the valley portion between the (m+2)-th turn and the (m+4)-th turn of the first wire 50. Note that a part of the ninth turn of the second wire 60 may belong to the second layer L2.

The 10th turn of the second wire 60 is wound adjacent to the third portion 73 on the second flange 31 side in the direction along the central axis X. That is, the 10th turn of the second wire 60 includes a portion wound on the second flange 31 side with respect to the first portion 71 in the direction along the central axis X. In other words, the second wire 60 includes at least one or more turns wound on the second flange 31 side with respect to the first portion 71 in the direction along the central axis X. Note that the configurations of the 10th and subsequent turns of the second wire 60 are similar to those of the first embodiment.

### Effects of Second Embodiment

In the second embodiment, in addition to effects similar to the effects (1-1) and (1-5) of the first embodiment, the following effects can be further obtained.

(2-1) In the second embodiment, the first wire 50 rides on the second layer L2 at two locations of the first portion 71 and the third portion 73. With this configuration, the space for winding the first wire 50 in the direction along the central axis X is further reduced as compared with the configuration in which the entire first wire 50 belongs to the first layer L1. Further, in the above configuration, the second wire 60 rides on the third layer L3 at three locations of the second portion 72, the fourth portion 74, and the fifth portion 75. Thus, the space for winding the second wire 60 in the direction along the central axis X is further reduced as compared with the configuration in which the entire second wire 60 belongs to the first layer L1 and the second layer L2.

(2-2) In the second embodiment, the m-th turn of the second wire 60 is located closer to the first flange 21 side than the m-th turn of the first wire 50 in the direction along the central axis X. Further, the (m+4)-th turn of the second wire 60 is located closer the second flange 31 side than the (m+4)-th turn of the first wire 50 in the direction along the central axis X. That is, when the anteroposterior relationship of the same turn of each wire is compared, the anteroposterior relationship is reversed from the n-th turn to the (m+4)-th turn. With such a configuration, the positive and negative of the stray capacitance can be changed before the m-th turn and after the (m+4)-th turn of the second wire 60.

### Modifications

The first embodiment and the second embodiment can be modified and implemented as follows. The first embodiment, the second embodiment, and modifications below can be implemented in combination within a range that is not technically contradictory.

In the first embodiment and the second embodiment, the configuration of the coil component 10 is not limited to the above configuration. For example, the coil component 10 need not include the plate core 10F. Further, the shape of the plate core 10F is not limited to a rectangular plate shape. For example, the plate core 10F may have an elliptical plate shape or the like.

In the first embodiment and the second embodiment, the shape of the winding core 11 is not limited to the example of the above embodiment. For example, the shape of the winding core 11 may be a columnar shape or a polygonal columnar shape other than a quadrangular columnar shape.

In the first embodiment and the second embodiment, the materials of the drum core 10C and the plate core 10F are not limited to the examples of the above embodiment. For example, the materials of the drum core 10C and the plate core 10F are not limited to Ni—Zn-based ferrite, and may be Mn—Zn-based ferrite or the like. In addition, the materials of the drum core 10C and the plate core 10F may be ferrite, alumina, a synthetic resin, a mixture thereof, or the like.

In the first embodiment and the second embodiment, the configuration of the drum core 10C is not limited to the example of the above embodiment. For example, the first flange 21 need not include the recessed portion 23. In this case, for example, it is sufficient if the first external electrode 41 and the second external electrode 42 are separated from each other. The same applies to the second flange 31.

In the first embodiment and the second embodiment, the materials and shapes of the first external electrode 41 to the fourth external electrode 44 are not limited to the examples of the respective embodiments. For example, the plating layers of the first external electrode 41 to the fourth external electrode 44 may be one layer having conductivity. In addition, the first external electrode 41 to the fourth external electrode 44 may include no plating layer, and a conductive metal layer may be exposed.

Further, for example, the first external electrode 41 to the fourth external electrode 44 may be formed by a plate-shaped metal material.

In the first embodiment and the second embodiment, the sectional shapes of the first wire 50 and the second wire 60 are not limited to the example of the above embodiment. For example, the sectional shape of the first wire 50 and the second wire 60 may be an elliptical shape, a rectangular shape, or the like.

In the first embodiment and the second embodiment, the total number of turns of the first wire 50 is not limited to the example of the above embodiment. The same applies to the total number of turns of the second wire 60. In addition, the total number of turns of the first wire 50 and the total number of turns of the second wire 60 may be different from each other.

In the first embodiment and the second embodiment, the length of the portion wound from the outside in the direction orthogonal to the central axis X on the valley portion between the m-th turn and the (m+1)-th turn of the first wire 50 in the n-th turn of the first wire 50, that is, the length of the first portion 71 is not limited. However, it is preferable that the length of the first portion 71 is sufficiently secured, and the first portion 71 is preferably wound by 0.5 turn or more on the valley portion between the m-th turn and the (m+1)-th turn of the first wire 50. The same applies to the second portion 72 to the fifth portion 75.

In the first embodiment and the second embodiment, the numbers of m and n are not limited to the example of the above embodiment as long as m is a positive integer and n is an integer equal to or greater than m+2. In addition, the number of a is not limited to the example of the above embodiment as long as a is an integer equal to or greater than 2.

In the first embodiment and the second embodiment, the turns belonging to the first layer L1 and the number of turns are not limited as long as the m-th turn and the (m+1)-th turn of the first wire 50 belong to the first layer L1. Further, as long as the n-th turn of the first wire 50 includes the first portion 71 wound from the outside in the direction orthogonal to the central axis X on the valley portion between the m-th turn and the (m+1)-th turn of the first wire 50, the turns belonging to the second layer L2 and the number of turns are not limited. Furthermore, as long as the a-th turn of the second wire 60 includes the second portion 72 belonging to the third layer L3, the turns belonging to the third layer L3 and the number of turns are not limited. That is, the turns belonging to the third layer L3 and the number of turns are not limited as long as the portion of the second wire 60 wound around the third layer L3 is at least one turn or more.

In the first embodiment and the second embodiment, as long as the second wire 60 includes at least one or more turns wound on the first flange 21 side with respect to the first portion 71 in the direction along the central axis X, the number of turns of the second wire 60 wound on the first flange 21 side with respect to the first portion 71 in the direction along the central axis X is not limited to the example of the above embodiment. Further, as long as the second wire 60 includes at least one or more turns wound adjacent to the first portion 71 on the second flange 31 side in the direction along the central axis X, the number of turns of the second wire 60 wound on the second flange 31 side with respect to the first portion 71 in the direction along the central axis X is not limited to the example of the above embodiment.

In the first embodiment and the second embodiment, in the second turn to the (m−1)-th turn, the second wire 60 may be located on the first flange 21 side in the direction along the central axis X with respect to the same turn of the first wire 50. In addition, in the (n+1)-th and subsequent turns, the first wire 50 may be located on the first flange 21 side in the direction along the central axis X with respect to the same turn of the second wire 60.

In the first embodiment, when the second wire 60 is traced from the first end 61 to the second end 62, all the turns of the second wire 60 need not be located closer to the second flange 31 side in the direction along the central axis X as the number of turns increases. It is sufficient if at least a portion of the second wire 60 continuously belonging to the second layer L2 is located closer to the second flange 31 side in the direction along the central axis X as the number of turns increases. However, the present disclosure is not limited thereto, and in the first embodiment, the second wire 60 need not be located closer to the second flange 31 side in the direction along the central axis X as the number of turns increases.

In the first embodiment, the m-th turn of the second wire 60 may be located closer to the first flange 21 side than the m-th turn of the first wire 50 in the direction along the central axis X, and the n-th turn of the second wire 60 may be located closer to the first flange 21 side than the n-th turn of the first wire 50 in the direction along the central axis X. For example, in the first embodiment, the 10th turn of the second wire 60 may be wound on a valley portion between the ninth turn of the second wire 60 and the 10th turn of the second wire 60. In addition, the m-th turn of the second wire 60 may be located closer the second flange 31 side than the m-th turn of the first wire 50 in the direction along the central axis X, and the n-th turn of the second wire 60 may be located closer to the second flange 31 side than the n-th turn of the first wire 50 in the direction along the central axis X.

In the second embodiment, the m-th turn of the second wire 60 may be located closer to the first flange 21 side than the m-th turn of the first wire 50 in the direction along the central axis X, and the (m+4)-th turn of the second wire 60 may be located closer to the first flange 21 side than the (m+4)-th turn of the first wire 50 in the direction along the central axis X. In addition, the m-th turn of the second wire 60 may be located closer to the second flange 31 side than the m-th turn of the first wire 50 in the direction along the central axis X, and the (m+4)-th turn of the second wire 60 may be located closer to the second flange 31 side than the (m+4)-th turn of the first wire 50 in the direction along the central axis X.

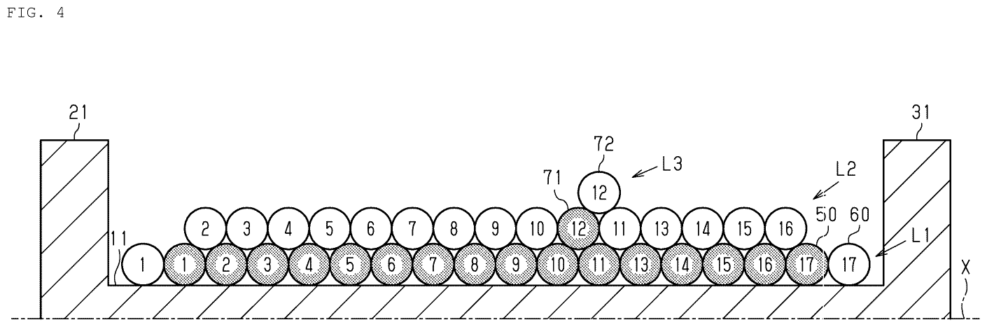

In the first embodiment, the second portion 72 is not limited to the ninth turn of the second wire 60. In the example illustrated in FIG. 4, the first turn to the middle of the 11th turn of the first wire 50 belong to the first layer L1. Further, the first turn to the 11th turn of the first wire 50 are sequentially wound so as to be located closer to the second flange 31 side in the direction along the central axis X as the number of turns increases. Further, each of the first turn to the 11th turn of the first wire 50 is wound adjacent to each other in the direction along the central axis X.

In this example, the 12th turn of the first wire 50 includes the first portion 71 belonging to the second layer L2. Specifically, the first portion 71 includes a first portion 71 wound from the outside in the direction orthogonal to the central axis X on the valley portion between the 10th turn and the 11th turn of the first wire 50. Thus, when n is 12 and m is 10 (n=m+2), the n-th turn of the first wire 50 includes the first portion 71 wound from the outside in the direction orthogonal to the central axis X on the valley portion between the m-th turn and the (m+1)-th turn of the first wire 50. Note that a part of the 12th turn of the first wire 50 may belong to the first layer L1. Further, a part of the 11th turn of the first wire 50 may belong to the second layer L2.

In this example, the 13th turn of the first wire 50 includes a portion belonging to the first layer L1. The portion is wound adjacent to the 11th turn of the first wire 50 on the second flange 31 side in the direction along the central axis X. Note that a part of the 13th turn of the first wire 50 may belong to the second layer L2.

The 14th turn to the 17th turn of the first wire 50 include a portion belonging to the first layer L1. The portion is wound adjacent to the 13th turn of the first wire 50 on the second flange 31 side in the direction along the central axis X. The 14th turn to the 17th turn of the first wire 50 are sequentially wound so as to be located closer to the second flange 31 side in the direction along the central axis X as the number of turns increases. Further, each of the 14th turn to the 17th turn of the first wire 50 is wound adjacent to each other in the direction along the central axis X. Further, although not illustrated, it is assumed that the first wire 50 includes the 18th turn and is drawn out from the winding core 11 in the middle of the 18th turn to be connected to the third external electrode 43. Note that, in FIG. 4, illustration of each wire on the lower surface of the winding core 11 is omitted.

In this example, the first turn of the second wire 60 includes a portion belonging to the first layer L1. The portion is wound adjacent to the first flange 21 side of the first turn of the first wire 50 in the direction along the central axis X. Note that a part of the second turn of the first wire 50 may belong to the first layer L1.

The second turn to the 10th turn of the second wire 60 belong to the second layer L2. The second turn to the 10th turn of the second wire 60 are sequentially wound so as to be located closer to the second flange 31 side in the direction along the central axis X as the number of turns increases. Each of the second turn to the 10th turn of the second wire 60 is wound adjacent to each other in the direction along the central axis X.

The 11th turn of the second wire 60 includes a portion belonging to the second layer L2. Specifically, the portion is wound from the outside in the direction orthogonal to the central axis X on the valley portion between the 11th turn and the 13th turn of the first wire 50. Further, the portion is wound adjacent to the 12th turn of the first wire 50 on the second flange 31 side in the direction along the central axis X. Further, the portion is located closer to the second flange 31 side than the 11th turn of the first wire 50 in the direction along the central axis X. Note that the second wire 60 may temporarily ride on the 12th turn of the first wire 50 from the 10th turn to the 11th turn of the second wire 60 and belong to the third layer L3. In this portion, since it is temporary riding on the third layer L3 in a minute section, the 10th turn to the 11th turn of the second wire 60 may be treated as belonging to the second layer L2 in the present disclosure.

The 12th turn of the second wire 60 includes a second portion 72 belonging to the third layer L3. Specifically, the second portion 72 includes a second portion 72 wound from the outside in the direction orthogonal to the central axis X on the valley portion between the 12th turn of the first wire 50 and the 11th turn of the second wire 60. That is, when a is 12, the a-th turn of the second wire 60 includes the second portion 72 belonging to the third layer L3. Further, a part of the 12th turn of the second wire 60 may be wound from the outside around a portion belonging to the third layer L3 in the 10th turn or the 11th turn of the second wire 60, and may include a portion located outside the third layer L3.

The 13th turn to the 16th turn of the second wire 60 belong to the second layer L2. The 13th turn to the 16th turn of the second wire 60 are sequentially wound so as to be located closer to the second flange 31 side in the direction along the central axis X as the number of turns increases. Each of the 13th turn to the 16th turn of the second wire 60 are wound adjacent to each other in the direction along the central axis X.

The 17th turn of the second wire 60 is wound similarly to the 15th turn of the second wire 60 of the first embodiment. Further, although not illustrated, it is assumed that the second wire 60 includes the 18th turn and is drawn out from the winding core 11 in the middle of the 18th turn to be connected to the fourth external electrode 44.

According to the example illustrated in FIG. 4, the second portion 72 of the second wire 60 is wound on the outside with respect to the first portion 71 of the first wire 50. Further, the second portion 72 and the first portion 71 are the same turns. Accordingly, a stray capacitance generated between the first wire 50 and the second wire 60 in these turns can be suppressed.

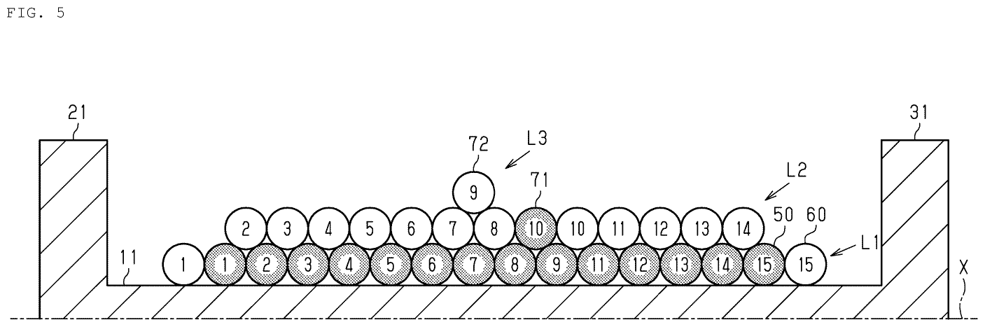

Further, in the example illustrated in FIG. 4, the second wire 60 is wound, as a turn smaller than the m-th turn, nine turns from the m-th turn on the first flange 21 side in the direction along the central axis X. On the other hand, the second wire 60 is wound, as a turn larger than the n-th turn, about five turns from the n-th turn on the second flange 31 side in the direction along the central axis X. As described above, since the number of turns wound around the first flange 21 side and the number of turns wound around the second flange 31 side are different from each other with the vicinity of the second portion 72 as a starting point, it is easy to specify the direction of the coil component 10 by visually recognizing these winding modes. In the first embodiment, the second portion 72 of the second wire 60 is not limited to being wound on the first portion 71 from the outside in the direction orthogonal to the central axis X. In the example illustrated in FIG. 5, the first wire 50 is wound as in the first embodiment. That is, when n is 10 and m is 8 (n=m+2), the n-th turn of the first wire 50 includes the first portion 71 belonging to the second layer L2. The first portion 71 is wound from the outside in the direction orthogonal to the central axis X on a valley portion between the m-th turn and the (m+1)-th turn of the first wire 50.

Further, the first turn to the eighth turn of the second wire 60 are wound as in the first embodiment. Furthermore, in the example illustrated in FIG. 5, the ninth turn of the second wire 60 includes the second portion 72 belonging to the third layer L3. That is, when a is 9, the a-th turn of the second wire 60 includes the second portion 72 belonging to the third layer L3. The 10th and subsequent turns of the second wire 60 are wound as in the first embodiment. Note that, in FIG. 5, illustration of each wire on the lower surface of the winding core 11 is omitted.

Similarly to the case of the first embodiment, a stray capacitance generated when the potential of the first wire 50 is higher than the potential of the second wire 60 by one turn when the turn of the first wire 50 and the turn of the second wire 60 in contact with each other are compared is defined as a positive unit capacitance A. Further, the stray capacitance generated when the potential of the second wire 60 is higher than the potential of the first wire 50 by one turn when the turn of the first wire 50 and the turn of the second wire 60 in contact with each other are compared is defined as a negative unit capacitance B.

In the example illustrated in FIG. 5, the coil component 10 includes eight positive unit capacitances A and seven negative unit capacitances B. Therefore, when the entire coil component 10 is viewed, a positive stray capacitance is larger than a negative stray capacitance by one unit capacitance A. As described above, it is possible to design the coil component 10 in which the stray capacitance generated by the high potential of the first wire 50 is larger than the stray capacitance generated by the high potential of the second wire 60.

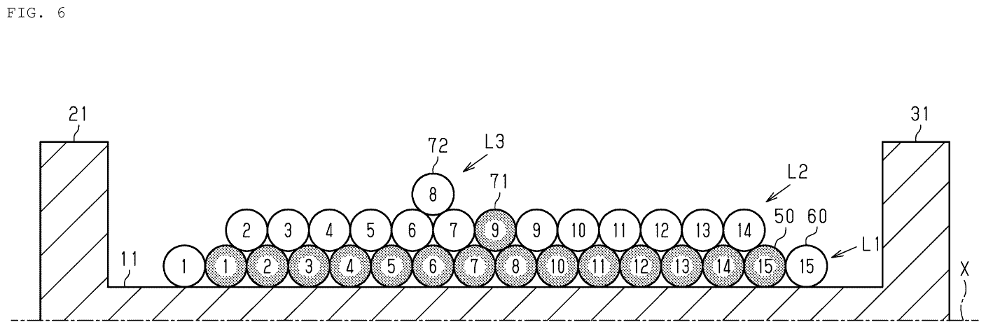

As a mode in which the second portion 72 of the second wire 60 is not limited to being wound on the first portion 71 from the outside in the direction orthogonal to the central axis X, a winding mode as in the example illustrated in FIG. 6 may be adopted. In the example illustrated in FIG. 6, the first turn to the middle of the eighth turn of the first wire 50 belong to the first layer L1. Further, the first turn to the eighth turn of the first wire 50 are sequentially wound so as to be located closer to the second flange 31 side in the direction along the central axis X as the number of turns increases. Further, each of the first turn to the eighth turn of the first wire 50 is wound adjacent to each other in the direction along the central axis X.

In this example, the ninth turn of the first wire 50 includes the first portion 71 belonging to the second layer L2. Specifically, the first portion 71 is wound from the outside in the direction orthogonal to the central axis X on the valley portion between the seventh turn and the eighth turn of the first wire 50. Thus, when n is 9 and m is 7 (n=m+2), the n-th turn of the first wire 50 includes the first portion 71 wound from the outside in the direction orthogonal to the central axis X on the valley portion between the m-th turn and the (m+1)-th turn of the first wire 50. Note that a part of the ninth turn of the first wire 50 may belong to the first layer L1. Further, a part of the eighth turn of the first wire 50 may belong to the second layer L2.

In this example, the 10th turn of the first wire 50 belongs to the first layer L1. The 10th turn of the first wire 50 includes a portion wound adjacent to the eighth turn of the first wire 50 on the second flange 31 side in the direction along the central axis X. Note that a part of the 10th turn of the first wire 50 may belong to the second layer L2. Further, the 11th and subsequent turns of the first wire 50 are wound as in the first embodiment.

In this example, the first turn to the sixth turn of the second wire 60 are wound as in the first embodiment. The seventh turn of the second wire 60 belongs to the second layer L2. Further, the seventh turn of the second wire 60 includes a portion wound adjacent to the ninth turn of the first wire 50 on the first flange 21 side in the direction along the central axis X. Note that a part of the seventh turn of the second wire 60 may belong to the third layer L3.

The eighth turn of the second wire 60 includes a second portion 72 belonging to the third layer L3. That is, when a is 8, the a-th turn of the second wire 60 includes the second portion 72 belonging to the third layer L3.

The ninth turn of the second wire 60 includes a portion belonging to the second layer L2. Specifically, the portion is wound from the outside in the direction orthogonal to the central axis X on the valley portion between the eighth turn and the 10th turn of the first wire 50. Further, the portion is wound adjacent to the ninth turn of the first wire 50 on the second flange 31 side in the direction along the central axis X. Note that a part of the ninth turn of the second wire 60 may belong to the third layer L3.

The 10th turn of the second wire 60 belongs to the second layer L2. Specifically, the 10th turn of the second wire 60 includes a portion wound from the outside in the direction orthogonal to the central axis X on the valley portion between the 10th turn and the 11th turn of the first wire 50. Further, the portion is wound adjacent to the ninth turn of the second wire 60 on the second flange 31 side in the direction along the central axis X. The 11th and subsequent turns of the second wire 60 are wound as in the first embodiment. Note that, in FIG. 6, illustration of each wire on the lower surface of the winding core 11 is omitted.

Similarly to the case of the first embodiment, the stray capacitance generated when the potential of the first wire 50 is higher than the potential of the second wire 60 by one turn when the turn of the first wire 50 and the turn of the second wire 60 in contact with each other are compared is defined as a positive unit capacitance A. Further, the stray capacitance generated when the potential of the second wire 60 is higher than the potential of the first wire 50 by one turn when the turn of the first wire 50 and the turn of the second wire 60 in contact with each other are compared is defined as a negative unit capacitance B.

In the example illustrated in FIG. 6, the coil component 10 includes seven positive unit capacitances A and eight negative unit capacitances B. Therefore, when the entire coil component 10 is viewed, a negative stray capacitance is larger than a positive stray capacitance by one unit capacitance B. As described above, it is possible to design the coil component 10 in which the stray capacitance generated by the high potential of the second wire 60 is larger than the stray capacitance generated by the high potential of the first wire 50.

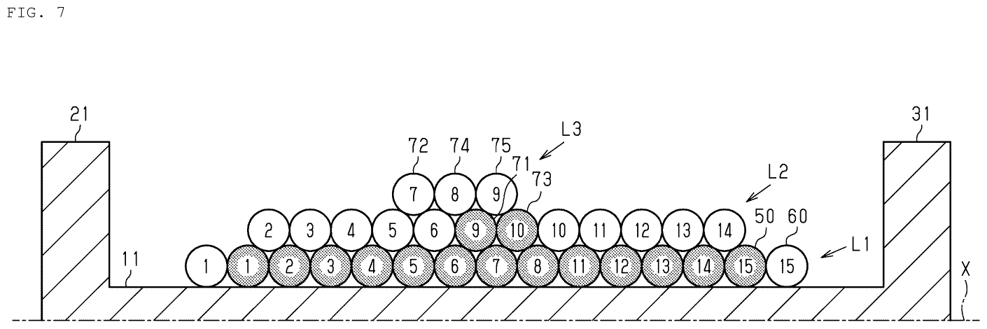

In the second embodiment, the first portion 71 is not limited to the (m+2)-th turn of the first wire 50. For example, in the example illustrated in FIG. 7, the first turn to the middle of the eighth turn of the first wire 50 belong to the first layer L1. Further, the first turn to the eighth turn of the first wire 50 are sequentially wound so as to be located closer to the second flange 31 side in the direction along the central axis X as the number of turns increases. Further, each of the first turn to the middle of the eighth turn of the first wire 50 is wound adjacent to each other in the direction along the central axis X. Note that a part of the eighth turn of the first wire 50 may belong to the second layer L2.

In this example, the ninth turn of the first wire 50 includes the first portion 71 belonging to the second layer L2. Specifically, the first portion 71 is wound from the outside in the direction orthogonal to the central axis X on the valley portion between the sixth turn and the seventh turn of the first wire 50. Thus, when n is 9 and m is 6 (n=m+3), the n-th turn of the first wire 50 includes the first portion 71 wound from the outside in the direction orthogonal to the central axis X on the valley portion between the m-th turn and the (m+1)-th turn of the first wire 50.

The 10th turn of the first wire 50 includes a third portion 73 belonging to the second layer L2. Specifically, the third portion 73 is wound from the outside in the direction orthogonal to the central axis X on the valley portion between the seventh turn and the eighth turn of the first wire 50. That is, the (m+4)-th turn of the first wire 50 includes the third portion 73 that belongs to the second layer L2 and is wound from the outside in the direction orthogonal to the central axis X on the valley portion between the (m+1)-th turn and the (m+2)-th turn of the first wire 50. Note that the 11th and subsequent turns of the first wire 50 are similar to those in the second embodiment.

The first turn to the seventh turn of the second wire 60 are similar to those in the second embodiment. The eighth turn of the second wire 60 includes a fourth portion 74 belonging to the third layer L3. Specifically, the fourth portion 74 is wound from the outside in the direction orthogonal to the central axis X on the valley portion between the sixth turn of the second wire 60 and the ninth turn of the first wire 50. In the second embodiment, the entire eighth turn of the second wire 60 is the fourth portion 74. That is, the (m+2)-th turn of the second wire 60 includes the fourth portion 74 that belongs to the third layer L3 and is wound from the outside in the direction orthogonal to the central axis X on the valley portion between the m-th turn of the second wire 60 and the (m+3)-th turn of the first wire 50.

The ninth turn of the second wire 60 includes a fifth portion 75 belonging to the third layer L3. Specifically, the fifth portion 75 is wound from the outside in the direction orthogonal to the central axis X on the valley portion between the ninth turn and the 10th turn of the first wire 50. That is, the (m+3)-th turn of the second wire 60 includes the fifth portion 75 that belongs to the third layer L3 and is wound from the outside in the direction orthogonal to the central axis X on the valley portion between the (m+3)-th turn and the (m+4)-th turn of the first wire 50.

The 10th turn of the second wire 60 belongs to the second layer L2. Specifically, the 10th turn of the second wire 60 includes a portion wound from the outside in the direction orthogonal to the central axis X on the valley portion between the eighth turn and the 11th turn of the first wire 50. The portion is wound adjacent to the 10th turn of the first wire 50 on the second flange 31 side in the direction along the central axis X. Note that a part of the 10th turn of the second wire 60 may belong to the third layer L3. The 11th and subsequent turns of the second wire 60 are similar to those in the second embodiment. Further, in FIG. 7, illustration of each wire on the lower surface of the winding core 11 is omitted.

In the example illustrated in FIG. 7, the first wire 50 is continuously wound around the first layer L1 from the m-th turn to the (m+2)-th turn. The (m+3)-th turn of the first wire 50 is located on the first flange 21 side with respect to the (m+2)-th turn in the direction along the central axis X. That is, the first wire 50 is wound back to the first flange 21 side from the (m+2)-th turn to the (m+3)-th turn. With such a configuration, the m-th turn and the (m+1)-th turn of the first wire 50 are pressed in the direction toward the first flange 21 side in the direction along the central axis X by the rewinding of the (m+3)-th turn from the (m+2)-th turn. In other words, the adjacent turns are closely wound from the m-th turn to the (m+2)-th turn of the first wire 50. With this configuration, the fourth portion 74 and the fifth portion 75 of the second wire 60 can be prevented from being stepped down and moving to the first layer L1.

### <Supplementary Note>

A technical idea that can be grasped from the above embodiment and modifications will be described.

[1] A coil component including a winding core, a first flange provided at a first end of the winding core in a direction along a central axis, a second flange provided at a second end of the winding core opposite to the first end, a first external electrode and a second external electrode provided on the first flange, a third external electrode and a fourth external electrode provided on the second flange, a first wire wound around the winding core and having a first end connected to the first external electrode and a second end connected to the third external electrode, and a second wire wound around the winding core in a same direction as the first wire. The second wire has a first end connected to the second external electrode and a second end connected to the fourth external electrode, in which regarding the first wire and the second wire, a number of turns increases by one every time one turn is made around the central axis from the first end toward the second end. Also, when a portion directly wound around the winding core is defined as a first layer, a portion wound from an outside of the first layer in a direction orthogonal to the central axis is defined as a second layer, and a portion wound from an outside of the second layer in the direction orthogonal to the central axis is defined as a third layer, an m-th turn (where m is a positive integer) and an (m+1)-th turn of the first wire include a portion belonging to the first layer, an n-th turn (where n is an integer equal to or greater than m+2) of the first wire includes a first portion that belongs to the second layer and is wound from the outside in the direction orthogonal to the central axis on a valley portion between the m-th turn and the (m+1)-th turn of the first wire, the second wire includes at least one or more turns wound on a side of the first flange with respect to the first portion in the direction along the central axis, and includes at least one or more turns wound on a side of the second flange with respect to the first portion in the direction along the central axis, and an a-th turn (where a is an integer equal to or greater than 2) of the second wire includes a second portion belonging to the third layer.

[2] The coil component according to [1], in which an m-th turn of the second wire is located closer to the side of the first flange than the m-th turn of the first wire in the direction along the central axis, and an n-th turn of the second wire is located closer to the side of the second flange than the n-th turn of the first wire in the direction along the central axis.

[3] The coil component according to [1] or [2], in which when same turns of the first wire and the second wire are compared with each other, the second wire is located on the side of the first flange with respect to the same turn of the first wire in the direction along the central axis in a second turn to an (m−1)-th turn, and in (n+1)-th and subsequent turns, the first wire is located on the side of the first flange with respect to the same turn of the second wire in the direction along the central axis.

[4] The coil component according to any one of [1] to [3], in which n=m+2, a portion where the second wire continuously belongs to the second layer when the second wire is traced from the first end to the second end is located closer to the side of the second flange in the direction along the central axis as the number of turns increases, an m-th turn of the second wire includes a portion that belongs to the second layer and is wound adjacent to an (m+2)-th turn of the first wire on the side of the first flange in the direction along the central axis, and an (m+1)-th turn of the second wire includes the second portion wound from the outside in the direction orthogonal to the central axis on a valley portion between the m-th turn of the second wire and the (m+2)-th turn of the first wire.

[5] The coil component according to any one of [1] to [3], in which n=m+2, an (m+1)-th turn of the second wire includes a portion that belongs to the second layer and is wound adjacent to an (m+2)-th turn of the first wire on the side of the second flange in the direction along the central axis, and an (m+2)-th turn of the second wire includes the second portion wound from the outside in the direction orthogonal to the central axis on a valley portion between the (m+2)-th turn of the first wire and the (m+1)-th turn of the second wire.

[6] The coil component according to any one of [1] to [3], in which n=m+2, an m-th turn of the second wire includes a portion that belongs to the second layer and is wound adjacent to an (m+2)-th turn of the first wire on the side of the first flange in the direction along the central axis, an (m−1)-th turn of the second wire includes a portion that belongs to the second layer and is wound adjacent to the m-th turn of the second wire on the side of the first flange in the direction along the central axis, and an (m+1)-th turn of the second wire is located closer to the side of the first flange than the (m+1)-th turn of the first wire in the direction along the central axis, and includes the second portion wound from the outside in the direction orthogonal to the central axis on a valley portion between the (m−1)-th turn of the second wire and the m-th turn of the second wire.

[7] The coil component according to [1], in which n=m+2, an (m+3)-th turn of the first wire includes a portion that belongs to the first layer and is wound adjacent to the (m+1)-th turn of the first wire on the side of the second flange in the direction along the central axis, and an (m+4)-th turn of the first wire includes a third portion that belongs to the second layer and is wound from the outside in the direction orthogonal to the central axis on a valley portion between the (m+1)-th turn of the first wire and the (m+3)-th turn of the first wire. Also, an m-th turn of the second wire includes a portion that belongs to the second layer and is wound adjacent to an (m+2)-th turn of the first wire on the side of the first flange in the direction along the central axis, an (m−1)-th turn of the second wire includes a portion that belongs to the second layer and is wound adjacent to the m-th turn of the second wire on the side of the first flange in the direction along the central axis, an (m+1)-th turn of the second wire includes the second portion wound from the outside in the direction orthogonal to the central axis on a valley portion between the (m−1)-th turn of the second wire and the m-th turn of the second wire, an (m+2)-th turn of the second wire includes a fourth portion that belongs to the third layer and is wound from the outside in the direction orthogonal to the central axis on a valley portion between the m-th turn of the second wire and the (m+2)-th turn of the first wire, and an (m+3)-th turn of the second wire includes a fifth portion that belongs to the third layer and is wound from the outside in the direction orthogonal to the central axis on a valley portion between the (m+2)-th turn of the first wire and the (m+4)-th turn of the first wire.

[8] The coil component according to [1] or [2], in which n=m+3, an (m+2)-th turn of the first wire includes a portion that belongs to the first layer and is wound adjacent to the (m+1)-th turn of the first wire on the side of the second flange in the direction along the central axis, and an (m+4)-th turn of the first wire includes a third portion that belongs to the second layer and is wound from the outside in the direction orthogonal to the central axis on a valley portion between the (m+1)-th turn of the first wire and the (m+2)-th turn of the first wire. Also, an m-th turn of the second wire includes a portion that belongs to the second layer and is wound adjacent to an (m+3)-th turn of the first wire on the side of the first flange in the direction along the central axis, an (m−1)-th turn of the second wire includes a portion that belongs to the second layer and is wound adjacent to the m-th turn of the second wire on the side of the first flange in the direction along the central axis, an (m+1)-th turn of the second wire includes the second portion wound from the outside in the direction orthogonal to the central axis on a valley portion between the (m−1)-th turn of the second wire and the m-th turn of the second wire, an (m+2)-th turn of the second wire includes a fourth portion that belongs to the third layer and is wound from the outside in the direction orthogonal to the central axis on a valley portion between the m-th turn of the second wire and the (m+3)-th turn of the first wire, and an (m+3)-th turn of the second wire includes a fifth portion that belongs to the third layer and is wound from the outside in the direction orthogonal to the central axis on a valley portion between the (m+3)-th turn of the first wire and the (m+4)-th turn of the first wire.

[9] The coil component according to [7] or [8], in which an m-th turn of the second wire is located closer to the first flange than the m-th turn of the first wire in the direction along the central axis, and an (m+4)-th turn of the second wire is located closer to the second flange than the (m+4)-th turn of the first wire in the direction along the central axis.

What is claimed is:

1. A coil component comprising:
a winding core;
a first flange at a first end of the winding core in a direction along a central axis;
a second flange at a second end of the winding core opposite to the first end;
a first external electrode and a second external electrode on the first flange;
a third external electrode and a fourth external electrode on the second flange;
a first wire wound around the winding core and having a first end connected to the first external electrode and a second end connected to the third external electrode; and
a second wire wound around the winding core in a same direction as the first wire, the second wire having a first end connected to the second external electrode and a second end connected to the fourth external electrode,
wherein regarding the first wire and the second wire,
a number of turns increases by one every time one turn is made around the central axis from the first end toward the second end, and
when a portion directly wound around the winding core is defined as a first layer,
a portion wound from an outside of the first layer in a direction orthogonal to the central axis is defined as a second layer, and
a portion wound from an outside of the second layer in the direction orthogonal to the central axis is defined as a third layer,
an m-th turn (where m is a positive integer) and an (m+1)-th turn of the first wire include a portion belonging to the first layer,
an n-th turn (where n is an integer equal to or greater than m+2) of the first wire includes a first portion that belongs to the second layer and is wound from the outside in the direction orthogonal to the central axis on a valley portion between the m-th turn and the (m+1)-th turn of the first wire,
the second wire includes at least one or more turns wound on a side of the first flange with respect to the first portion in the direction along the central axis, and includes at least one or more turns wound on a side of the second flange with respect to the first portion in the direction along the central axis, and
an a-th turn (where a is an integer equal to or greater than 2) of the second wire includes a second portion belonging to the third layer.

2. The coil component according to claim 1, wherein
an m-th turn of the second wire is closer to the side of the first flange than the m-th turn of the first wire in the direction along the central axis, and
an n-th turn of the second wire is closer to the side of the second flange than the n-th turn of the first wire in the direction along the central axis.

3. The coil component according to claim 1, wherein
when same turns of the first wire and the second wire are compared with each other, the second wire is on the side of the first flange with respect to the same turn of the first wire in the direction along the central axis from a second turn to an (m−1)-th turn, and
in (n+1)-th and subsequent turns, the first wire is on the side of the first flange with respect to the same turn of the second wire in the direction along the central axis.

4. The coil component according to claim 1, wherein
n=m+2,
a portion where the second wire continuously belongs to the second layer when the second wire is traced from the first end to the second end is closer to the side of the second flange in the direction along the central axis as the number of turns increases,
an m-th turn of the second wire includes a portion that belongs to the second layer and is wound adjacent to an (m+2)-th turn of the first wire on the side of the first flange in the direction along the central axis, and
an (m+1)-th turn of the second wire includes the second portion wound from the outside in the direction orthogonal to the central axis on a valley portion between the m-th turn of the second wire and the (m+2)-th turn of the first wire.

5. The coil component according to claim 1, wherein
n=m+2,
an (m+1)-th turn of the second wire includes a portion that belongs to the second layer and is wound adjacent to an (m+2)-th turn of the first wire on the side of the second flange in the direction along the central axis, and
an (m+2)-th turn of the second wire includes the second portion wound from the outside in the direction orthogonal to the central axis on a valley portion between the (m+2)-th turn of the first wire and the (m+1)-th turn of the second wire.

6. The coil component according to claim 1, wherein
n=m+2,
an m-th turn of the second wire includes a portion that belongs to the second layer and is wound adjacent to an (m+2)-th turn of the first wire on the side of the first flange in the direction along the central axis,
an (m−1)-th turn of the second wire includes a portion that belongs to the second layer and is wound adjacent to the m-th turn of the second wire on the side of the first flange in the direction along the central axis, and
an (m+1)-th turn of the second wire is closer to the side of the first flange than the (m+1)-th turn of the first wire in the direction along the central axis, and includes the second portion wound from the outside in the direction orthogonal to the central axis on a valley portion between the (m−1)-th turn of the second wire and the m-th turn of the second wire.

7. The coil component according to claim 1, wherein
n=m+2,
an (m+3)-th turn of the first wire includes a portion that belongs to the first layer and is wound adjacent to the (m+1)-th turn of the first wire on the side of the second flange in the direction along the central axis,
an (m+4)-th turn of the first wire includes a third portion that belongs to the second layer and is wound from the outside in the direction orthogonal to the central axis on a valley portion between the (m+1)-th turn of the first wire and the (m+3)-th turn of the first wire,
an m-th turn of the second wire includes a portion that belongs to the second layer and is wound adjacent to an (m+2)-th turn of the first wire on the side of the first flange in the direction along the central axis,
an (m−1)-th turn of the second wire includes a portion that belongs to the second layer and is wound adjacent to the m-th turn of the second wire on the side of the first flange in the direction along the central axis,
an (m+1)-th turn of the second wire includes the second portion wound from the outside in the direction orthogonal to the central axis on a valley portion between the (m−1)-th turn of the second wire and the m-th turn of the second wire,
an (m+2)-th turn of the second wire includes a fourth portion that belongs to the third layer and is wound from the outside in the direction orthogonal to the central axis on a valley portion between the m-th turn of the second wire and the (m+2)-th turn of the first wire, and
an (m+3)-th turn of the second wire includes a fifth portion that belongs to the third layer and is wound from the outside in the direction orthogonal to the central axis on a valley portion between the (m+2)-th turn of the first wire and the (m+4)-th turn of the first wire.

8. The coil component according to claim 1, wherein
n=m+3,
an (m+2)-th turn of the first wire includes a portion that belongs to the first layer and is wound adjacent to the (m+1)-th turn of the first wire on the side of the second flange in the direction along the central axis,
an (m+4)-th turn of the first wire includes a third portion that belongs to the second layer and is wound from the outside in the direction orthogonal to the central axis on a valley portion between the (m+1)-th turn of the first wire and the (m+2)-th turn of the first wire,
an m-th turn of the second wire includes a portion that belongs to the second layer and is wound adjacent to an (m+3)-th turn of the first wire on the side of the first flange in the direction along the central axis,
an (m−1)-th turn of the second wire includes a portion that belongs to the second layer and is wound adjacent to the m-th turn of the second wire on the side of the first flange in the direction along the central axis,
an (m+1)-th turn of the second wire includes the second portion wound from the outside in the direction orthogonal to the central axis on a valley portion between the (m−1)-th turn of the second wire and the m-th turn of the second wire,
an (m+2)-th turn of the second wire includes a fourth portion that belongs to the third layer and is wound from the outside in the direction orthogonal to the central axis on a valley portion between the m-th turn of the second wire and the (m+3)-th turn of the first wire, and
an (m+3)-th turn of the second wire includes a fifth portion that belongs to the third layer and is wound from the outside in the direction orthogonal to the central axis on a valley portion between the (m+3)-th turn of the first wire and the (m+4)-th turn of the first wire.

9. The coil component according to claim 7, wherein
an m-th turn of the second wire is closer to the first flange than the m-th turn of the first wire in the direction along the central axis, and
an (m+4)-th turn of the second wire is closer to the second flange than the (m+4)-th turn of the first wire in the direction along the central axis.

10. The coil component according to claim 8, wherein
an m-th turn of the second wire is closer to the first flange than the m-th turn of the first wire in the direction along the central axis, and
an (m+4)-th turn of the second wire is closer to the second flange than the (m+4)-th turn of the first wire in the direction along the central axis.
